(19) United States
(12) Patent Application Publication
(10) Pub. No.: US 2002/0014216 A1
(43) Pub. Date: Feb. 7, 2002

(54) Control device for a starter of an internal combustion engine

(76) Inventors: Karlheinz Boegner, Neuhausen (DE); Bernhard Steffan, Ludwigsburg (DE); Wolfgang Seils, Ludwigsburg (DE)

Correspondence Address: STRIKER, STRIKER & STENBY, 103 East Neck Road, Huntington, NY, 11743, US

(21) Appl. No.: 09/904,307

(22) Filed: Jul. 12, 2001

(30) Foreign Application Priority Data
Jul. 18, 2000 (DE) 100 34 779.1

(51) Int. Cl. F02N 11/08

(52) U.S. Cl. 123/179.3; 290/38 R

(57) ABSTRACT

The control device for a starter of an internal combustion engine includes an engaging and holding coil for a starter pinion; a main connecting bridge for the starter, terminals for a starter motor winding of the starter, a ground terminal connected to ground, an operating voltage terminal, a main switching device for starter motor operation, a switching transistor (T1), especially a MOSFET, having a collector-emitter path between the engaging and holding coil and the ground terminal and an electronic starter controller for controlling the switching transistor.

### BACKGROUND OF THE INVENTION

1. Field of the Invention

The present invention relates to a control device for starter of an internal combustion engine and, more particularly, to a control device for a starter of an internal combustion engine including a main connecting bridge of the starter, an engaging and holding coil for the starter pinion and the main connecting bridge, terminals for the starter motor winding of the starter, a ground terminal connected to ground, an operating voltage terminal, a main switching device for starter motor operation and an electronic starter controller.

2. Related Art

The so-called pre-meshing and engaging is controlled by the starter relay in current conventional starter devices for starting internal combustion engines. The starter relay takes charge of the first meshing of the pinion with the crown gear—in other words, the engagement of the starter gear with the gear coupled with the crankshaft of the internal combustion engine—as well as the subsequent closing of the main connecting bridge—in other words the main circuit part of the supply branch for the starter motor winding. The starter motor for the internal combustion engine rotates with the full starter motor torque after closing the main connecting bridge.

The starter relay can be controlled by means of the ignition switch of the vehicle equipped with the internal combustion engine or it can occur by means of a special preliminary switching relay when the starter relay has high current requirements.

As an alternative the so-called high-side switching devices are used. These so-called high-side switching devices are npn transistors or n-ch-enhanced MOSFETs with additional internal charge pumps. These field effect transistors are switched by logic signals with respective levels of, for example, 0 and 5 volts. Their collectors on one side are connected to the operating voltage, also to the power supply. This type of circuitry is practically identical to the circuitry of a preliminary switching relay and thus compatible with conventional vehicle cable harnesses for starter terminal contacts.

To an increasing extent the engine control unit performs the starter motor control in connection with intelligent engine control. A start signal is sent to the starter electronics via a signal interface and then the starter electronics is activated. This signal interface can, for example, be a pulse code-modulated, unidirectional connection, such as a bit-synchronized interface, or also can be a CAN bus.

The engine control unit subsequently permits the performance of additional operations besides starter control, such as an automatic termination of the starting process, when the engine control unit detects that the engine is running. Furthermore the engine control unit can be used for starter diagnostics based on start count, start duration and surrounding temperature, which can be used for preventive maintenance procedures. Finally the maximum start duration can be limited or determined by the engine control unit, in order to avoid mishandling of the starter motor, discharge of the battery or starter motor overheating.

An additional problem in connection with starting process involves first meshing and engagement of the starter pinion. In conventional relay control the starter pinion rapidly engages in the crown gear connected to the crankshaft. Frequently undesirable heavy wear on the gear teeth sides occurs due to tooth-to-tooth relative positions on both gears. The so-called gentle first meshing avoids this problem. The relay current is controlled over fractions of a second so that after initially starting the pinion it is not accelerated with a higher force than initially applied and thus does not strike or impact strongly on the crown gear. Subsequently the relay current is set at a maximum value when the pinion meshes with the crown gear and reliably engages with it. Finally the main connecting bridge is reliably closed with as little rebound or bouncing as possible. The relay is closed and supplied with its holding current, which is about 0.2 to 0.4 times the engaging current.

The newest developments in starter control devices, especially for heavy-starting-torque commercial vehicle starters, include improvements of the engagement behavior, which are attained by a two-stage starting process. The running control occurs by means of an electronic starter control device, which controls two high-side transistors connected to each other with their collector-emitter paths connected in series. Current is supplied to a starter relay with a built-up resistance by means of one of these transistors, so that the starter motor is first operated with reduced torque. The relay coil is first controlled pulsed so that the pinion slowly travels to the crown gear. The rotational motion of the starter motor makes finding the tooth gaps comparatively easy and the slow pinion motion reduces the wear that occurs when the pinion meets the crown gear. An especially gentle engagement of the pinion with the crown gear occurs in this starting arrangement.

In the second stage of the starting process with this starting arrangement the engaging or drawing-in relay is supplied with its full current so that the pinion can completely engage in the crown gear. Accordingly the main connecting bridge closes and the starter motor rotates and delivers its full torque.

The above-described high-side transistors are the so-called Smart-Power MOSFETs, which are formed by n-MOSFETs with integrated charge pumps and integrated monitoring electronics for short circuit and excessive temperature detection. The high cost of these Smart-Power MOSFETs is comparatively disadvantageous.

### SUMMARY OF THE INVENTION

It is an object of the present invention to provide an improved control device for a starter of an internal combustion engine, which does not have the above-described disadvantages.

It is another object of the present invention to provide an improved control device for a starter of an internal combustion engine, in which the above-described advantageous operating features, such as the gentle engagement of the pinion with the crown gear on the crankshaft are maintained with the help of an electronic starter control device, but which does not include the expensive Smart-Power MOSFETs in high-side circuitry.

These objects, and others, which will be made more apparent hereinafter, are attained in a control device for a starter of an internal combustion engine including a main connecting bridge for the starter, an engaging and holding coil for the starter pinion and for the main connecting bridge for the starter, terminals for the starter motor winding of the starter, a ground terminal connected to ground, an operating voltage terminal, a main switching device for starter motor operation and an electronic starter controller.

According to the invention a standard switching transistor, especially a MOS field effect transistor, controlled by the electronic starter controller, is connected as a switching element with its collector-emitter path between the engaging and holding coil and the ground terminal. A starting device having this standard switching transistor attains the above-described objects of the invention. Furthermore no high-side circuitry is present in this starting device, but instead low-side circuitry is present. Standard npn transistors or n-ch-enhanced MOSFETs without charge pumps can be used as the standard switching transistor. The latter devices have the smallest voltage drop and thus the smallest losses so that they are predestinated for the present application. However the already-mentioned npn transistors or IGBT transistors can also be used.

The basic advantages of the control device according to the invention include a simple and economical structure, minimal space requirements and the avoidance of reverse polarity protection. To avoid repetition these advantages are made clearer in reference to the embodiments described in more detail hereinbelow and to the embodiments claimed in the appended claims.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a schematic diagram of a first embodiment of a control device for a starter of an internal combustion engine according to the invention;

FIG. 2 is a schematic diagram of a second embodiment of a control device for a starter of an internal combustion engine according to the invention;

FIG. 3 is a schematic diagram of a third embodiment of a control device for a starter of an internal combustion engine according to the invention;

FIG. 4 is a schematic diagram of a fourth embodiment of a control device for a starter of an internal combustion engine according to the invention; and

FIG. 5 is a schematic diagram of a fifth embodiment of a control device for a starter of an internal combustion engine according to the invention.

### DETAILED DESCRIPTION OF THE INVENTION

The basic embodiment of the control device for a starter of an internal combustion engine is shown in FIG. 1. The individual starter is symbolized by the motor winding M, which is supplied with current by means for the two motor winding terminals 1, 2 of the control device. The control device also has an operating voltage terminal 3, which is connected to a motor winding terminal 1 on one side of the starter by means of the main connecting bridge 4 for the starter relay in a first control device branch. The motor winding terminal 2 of the motor winding is connected to ground by means of the ground terminal 5.

A second control device branch—half branch 8—is connected in parallel to the main connecting bridge 4 and the motor winding M between the operating voltage terminal 3 and the ground terminal 5. This half branch 8 includes the ignition switch 6 in its first stage (“ignition switch OPEN”) as the main switching device for starter operation. The ignition switch 6 is connected in series in this half branch 8 with a combined engaging and holding coil W, which is provided for activation of an unshown starter pinion and the main connecting bridge 4 of the starter. A standard switching transistor T1 is connected with its collector-emitter path in series between the engaging and holding coil 5 and the ground terminal 5 in the half branch 8.

The transistor T1 is controlled by a conventional electronic starter controller ESC, which is connected by means of an interface 7 with the unshown engine control unit. A free-running diode D1 is connected in parallel to the engaging and holding coil W.

In operation of the control device according to FIG. 1 when the ignition switch 6 is closed by means of the electronic starter controller ESC the transistor T1 is put in the conducting state, in which the current flow through the coil W is controlled so that a temporary gentle first meshing and engagement and closing of the main connecting bridge 4 takes place. As soon as the engine runs, the electronic starter controller ESC receives an appropriate signal from the engine control unit and blocks the transistor T1. The starter pinion is disengaged because of that and the main connecting bridge 4 is again opened. When the main connecting bridge 4 operating as the main operating switch for the vehicle remains closed, a voltage is continuously applied to the coil side terminal of transistor T1. The corresponding terminal must thus be protected from a short circuit to ground, since otherwise an undesired engagement of the starter is possible. An integration of this element in the starter is indicated. Usually the control device according to FIG. 1 is characterized by a simple and economical structure and reduced spatial requirements. It is built into the starter itself and/or the starter relay. A reverse polarity protection is not required, since a connection in operation leads to a power supply short circuit, but not to an undesired starting process.

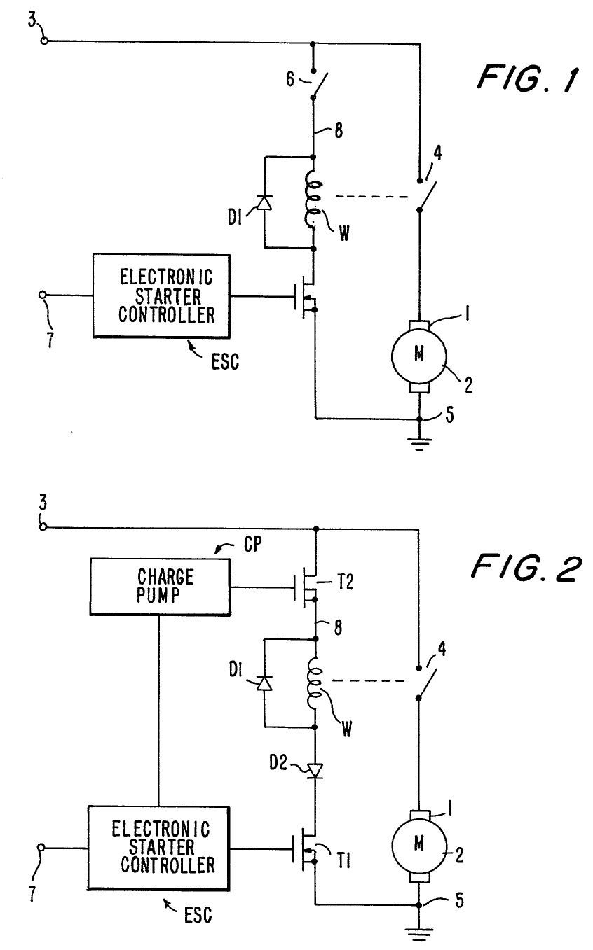

The embodiment of the control device according to the invention shown in FIG. 2 differs in two details from the control device shown in FIG. 1. To avoid repetition only the differences are explained in the following explanation. Generally multiple recitations are avoided by providing identical reference numbers for structural elements that are of the same type and function.

The principle difference between the embodiment of FIG. 1 and that of FIG. 2 is that an additional transistor, namely the starter-switching transistor T2, is connected in series between the operating voltage terminal 3 and the combined engaging and holding coil W, instead of the ignition switch. The electronic starter controller ESC controls the starter-switching transistor T2 in this embodiment by means of a charge pump CP. The latter component is especially necessary, when the starter-switching transistor T2 is embodied as an n-ch MOSFET. The charge pump CP is generally not necessary when the transistor T2 is embodied as a suitably powerful pnp transistor or a p-ch MOSFET.

A reverse polarity protecting diode D2 is connected between the coil W and the transistor T1 as a further addition to the simple embodiment according to FIG. 1, in order to prevent an undesired starting due to electrical excitation of the starter motor.

No significant differences exist between the operation of the control device according to FIG. 2 and the control device as embodied in FIG. 1. The coil W and the transistor T1 are potential-free (no voltage drop is present across these components) after the starting process because of the blocking of the transistor T2.

The embodiment of FIG. 2 has the advantage that its structure is adapted for connection with outside cables. A cable short circuit does not lead to an undesirable starting with the coil W. Furthermore no cable harness changes are necessary in the cable harness of a vehicle which is equipped with the standard cable harness. The conventional cabling steps and cable harness clamps can be used in assembly.

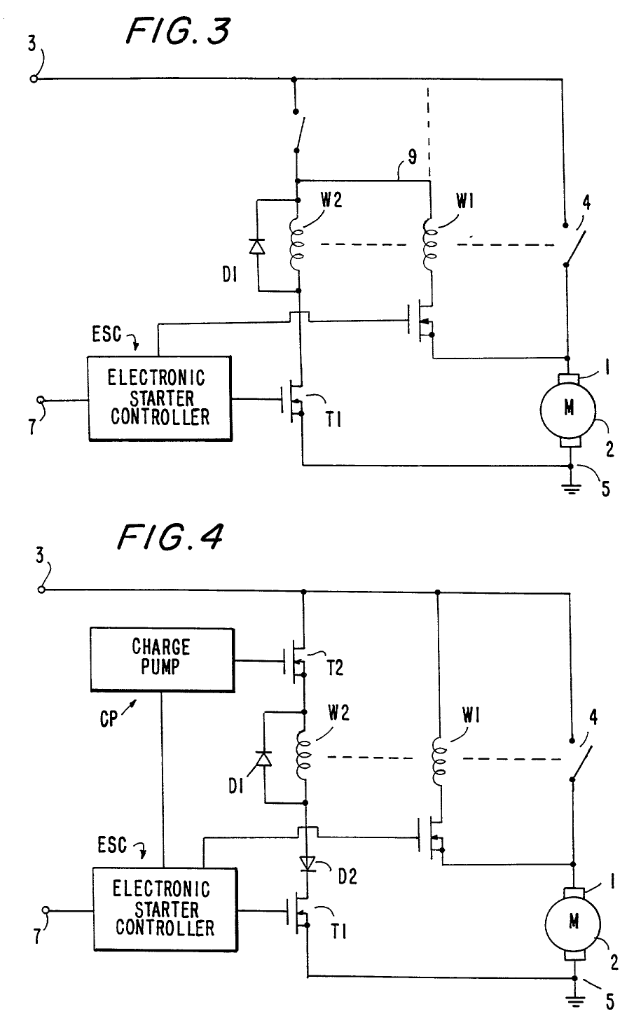

No combined engaging and holding coil is provided in the embodiment shown in FIG. 3. Instead two separate coils W1 and W2 are provided, one for engagement of the pinion and the other for holding the pinion. The conventional coil W2 comprises copper wire and, analogous to that in the embodiment according to FIG. 1, is connected in a half branch or holding branch 8 connected between the ignition switch 6 and the switching transistor T1. Furthermore a transverse branch 9 branches from a node in the branch 8 between the ignition switch 6 and the standard or conventional coil W2. The transverse branch 9 includes an additional switching transistor T3 and an auxiliary coil W1, which is wound from resistance wire, for example Constantan or a CuNi23Mn alloy. This further switching transistor T3 is connected with its collector-emitter path between the conventional coil W2 and the operating voltage-side terminal 1 of the motor winding M. The transistor T3 is connected with its base terminal with the electronic starter controller ESC and is controlled by it. The auxiliary coil W1, because of the use of the resistance wire for it, has a temperature independent resistance so that the current and current fluctuations passing through this coil are temperature independent.

The operation of the control device according to FIG. 3 is explained in the following paragraphs.

When the ignition switch 6 is closed the transistor T3 is switched on or made conducting by the electronic starter controller ESC, so that current flows through the starter motor winding M via the auxiliary coil W1. The current flowing through the starter motor winding M is limited however by the resistance of the auxiliary coil W1, whereby the starter is rotated comparatively slowly. The current flowing through the auxiliary coil W1 alone is not sufficient to engage the pinion of the starter. This latter feature protects against unintended or undesired starting due to a conducting transistor T3. The coil design and the temperature independence of the resistance of the auxiliary coil W1 guarantee this protective feature.

After starting the starter motor rotation by flowing current through the auxiliary coil W1 after about 20 to 50 ms the actual engagement of the pinion takes place, since the conventional coil W2 is also supplied with current by means of the transistor T1. The starter completely engages then and the main connecting bridge 4 is closed. Then because the main connecting bridge 4 is closed the auxiliary coil W1 becomes currentless, since there is then no voltage drop across it. No free-running diode connected in parallel across the auxiliary coil W1 is necessary because of this feature. In this state the conventional coil W2 provides a reduced holding current for the main connecting bridge 4. After a successful starting event the transistors T1, T3 are blocked so that the main connecting bridge 4 opens and the starter pinion is retracted.

The embodiment shown in FIG. 3 provides an advantageous freedom for the design of the starter relay because of the presence of the two coils W1, W2. This is particularly due to the temperature independence of the starter relay. Furthermore the current flow through the second or conventional coil W2 can be made comparatively small, because of the twin effects of the current flow through the auxiliary coil W1. These twin effects include the rotation of the starter motor and the current flow and thus relay force generation for the main connecting bridge 4. The transistor T1 and the free-running diode D1 can be constructed as integrated or hybridized chip components. No cooling bodies are necessary in the corresponding design.

Furthermore an unintended or undesired starting event does not occur when the transistor T3 is conducting because of the temperature independent properties of the coil W2. An undesired starting event can of course result at lower temperatures and because of the lower resistance of the copper material of the coil W2 when the other transistor T1 is conducting, which however is avoidable by means of the ignition switch 6. A polarity reverse protection device is not necessary.

A variant of the embodiment of the control device according to the invention is shown with dashed lines in FIG. 3. The transverse branch 9 with the coil W1 and the transistor T3 is not connected to the node in the branch between the ignition switch 6 and the coil W2, but instead is directly connected to the operating voltage terminal 3. The ignition switch 6 must thus carry only the reduced coil current that passes through the coil W2, which is of advantage for certain applications. Generally the coil W1 does not have polarity reversal protection in this variant, so that a suitable polarity protected connecting and cable harness form is provided.

As a further development of the above-recited variants with the auxiliary coil directly connected to the operating voltage terminal—as shown in FIG. 4—the ignition switch 6, again analogous to FIG. 2, is replaced by a transistor T2 with a charge pump CP, which is controlled by the electronic starter controller ESC. This embodiment of the control device has the advantages already described in connection with FIGS. 2 and 3, as well as the freedom for design of the relay because of the two coils W1 and W2 and of the reduced current through the conventional coil W2. Because of these features the electronic components arranged in the holding branch 8, namely the transistors T1, T2 and the diodes D1 and D2, can be designed as integrated or hybridized chip components.

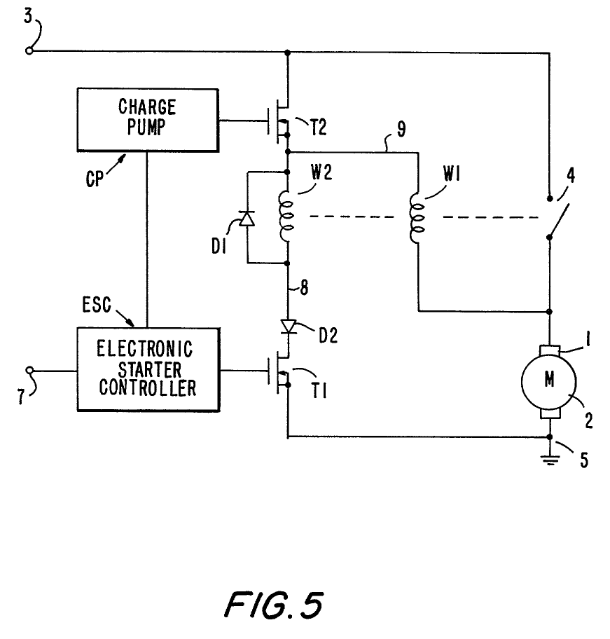

The embodiment shown in FIG. 5 differs from that shown in FIG. 4 because only the auxiliary coil W1, not an additional switching transistor, is arranged in the transverse branch 9. The function of the additional switching transistor is taken over by a connection of the transverse branch 9 between the starter-switching transistor T2 and the conventional coil W2.

Accordingly the switching on of the current through the auxiliary coil W1 occurs as an additional operation by first switching on the transistor T2. Subsequently the transistor T1 is switched on, whereby the engagement of the starter occurs. When the main connecting bridge 4 is closed the transistor T2 is currentless. Suitable clocking or pulsing of the transistor T1 controls the holding stage. The current supply is provided “backwards” by means of the main connecting bridge 4 and the auxiliary coil W1.

The circuitry technology required for the embodiment shown in FIG. 5 is less expensive than that required for the embodiment of FIG. 4.

The advantages of the control device according to the invention are summarized in the following paragraphs.

The circuitry for the control device allows the use of standard MOSFETs, which leads to a better circuit design than with the standard concept with the so-called high-side power transistors. Furthermore more degrees of freedom for starter relay design are provided by the embodiments with two separate coils used with the above-described current flow division, including the coil for engaging and holding of the pinion with the crown gear and a temperature-independent coil for rotation and engagement.

Improved operability is provided according to the following procedure by installing the control device in a complete motor or engine management system with an engine control unit.

The starter is activated by transmission of a signal from the engine control unit over a signal line or by means of a bus interface. The control device also has an amplifying effect so that the engine control unit only needs to switch reduced current. Furthermore the starter activation permits additional engine control operations to occur, such as a contactless driver identification or a so-called tip-start, in which the driver operates a starting pressure switch and the starting process is operated automatically, when the motor runs. A consumption-reducing start-stop operation with automatic engine shut off, when the vehicle is stopped and with an automatic restart on operation of the gas pedal, is possible. Finally, a considerable increase in service life with optimum reduced starter operating duration occurs because of a maximum starter operation time limit, temperature monitoring, gentle engagement of the pinion and possible tip-start.

The disclosure in German Patent Application 100 34 779.7 of Jul. 18, 2000 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a control device for a starter of an internal combustion engine, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A control device for a starter of an internal combustion engine comprising a main connecting bridge (4) for the starter; an engaging and holding coil (W, W1, W2) for a starter pinion and for the main connecting bridge (4); terminals (1, 2) for a starter motor winding of the starter; a ground terminal (5) connected to ground; an operating voltage terminal (3); a main switching device (6, T2) for starter motor operation; a switching transistor (T1) having a collector-emitter path between the engaging and holding coil and the ground terminal and an electronic starter controller (ESC) for controlling the switching transistor.

2. The control device as defined in claim 1, wherein said switching transistor (T1) is a MOS field effect transistor.

3. The control device as defined in claim 1, wherein said main switching device comprises an ignition switch (6).

4. The control device as defined in claim 1, further comprising a charge pump (CP) and wherein said main switching device comprises another switching transistor (T2) connected between the operating voltage terminal (3) and the engaging and holding coil (W, W1, W2) and said electronic starter controller (ESC) is connected by means of said charge pump (CP) with said another switching transistor (T2).

5. The control device as defined in claim 1, further comprising a polarity reversing diode (D2) connected between said engaging and holding coil and said switching transistor.

6. The control device as defined in claim 1, further comprising a switchable auxiliary coil (W1) of resistance wire connected in parallel and across said engaging and holding coil for supplying said starter motor winding (M) with current and for closing the main connecting bridge (4).

7. The control device as defined in claim 6, further comprising a further switching transistor (T3) for switching said auxiliary coil (W1) and wherein said further switching transistor (T3) is connected between said motor winding (M) and said auxiliary coil (W1) and said electronic switching controller (ESC) includes means for controlling said further switching transistor (T3).
